(19) United States
(12) Patent Application Publication
(10) Pub. No.: US 2011/0267575 A1
(43) Pub. Date: Nov. 3, 2011

(54) EYEWEAR

(76) Inventor: Lee Peter BATEY, Queensland (AU)

(21) Appl. No.: 13/101,284

(22) Filed: May 5, 2011

Related U.S. Application Data
(63) Continuation-in-part of application No. PCT/AU2009/001469, filed on Nov. 5, 2009.

(30) Foreign Application Priority Data
Nov. 5, 2008 (AU) 2008905706

(51) Int. Cl. G02C 3/00

(52) U.S. Cl. 351/62

(57) ABSTRACT

Eyewear for use by a wearer, said eyewear providing a substantially fluid tight seal about the wearer's eyes, the eyewear including at least one lens for positioning at least partially in front of a wearer's eyes; a frame adapted to mount the at least one lens for positioning the at least one lens in front of the eyes of the wearer; head mounting means adapted to attach the frame relative to a wearer's head; and at least one seal attached relative to said frame and located about a periphery of the wearer's eyes wherein the eyewear is wearable in a substantially fluid tight condition in which the at least one seal forms a substantially fluid tight seal about the wearer's eyes, and a free condition in which the eyewear is wearable with the seal spaced from the wearer's eyes.

### CROSS-REFERENCE TO RELATED APPLICATIONS

This application is a continuation-in-part of PCT application no. PCT/AU2009/001469 filed Nov. 5, 2009, which claims the benefit of Australian Application No. 2008905706, filed Nov. 5, 2008, in the Australian Intellectual Property Office, the disclosure of which is incorporated herein by reference.

### BACKGROUND OF THE INVENTION

1. Field of the Invention

The present invention relates to eyewear and particularly to eyewear adapted to be used as glasses and also provide an air/water tight seal between the glasses and the wearer' face.

2. Description of the Related Art

There are many endeavours in which the participant is preferably equipped with the eyewear that protects the wearer's eyes from hostile or annoying elements of the environment.

Examples of hostile elements include water, chemicals (whether waterborne or airborne), extreme temperature, or airborne particulars such as dust, dirt, smoke and the like, and sunlight.

Traditional eyeglass solutions provide a wearer with the basic protection from sunlight with some ancillary protection from more hostile conditions. Traditional goggle-type solutions manufacture a flexible seal material which is can formal ball to the shape of the wearer's face through the application of tension to the frame using a flexible strap. The flexible strap pulls the eyeglass frame against the wearer's face to provide an air/watertight seal between the eyeglass frame and the wearer's skin.

Various materials have been used to form the seal but most cause skin irritation and do not adequately shape to the individual's facial contours. Further, providing a more rigid seal material can result in constricting blood circulation to areas surrounding the eye socket when tension is applied. Consequently, the eyewear of this form cannot be used for extended periods of time.

Still further, goggle-type solutions do not generally provide vision correction and must either be worn in conjunction with the wearer's eyeglasses or, custom-made goggles must be used which are generally expensive and cannot be mass produced. Carrying multiple types of eyewear is extremely inconvenient.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to eyewear, which may at least partially overcome at least one of the abovementioned disadvantages or provide the consumer with a useful or commercial choice.

With the foregoing in view, the present invention in one form, resides broadly in eyewear for use by a wearer, said eyewear adapted to provide a substantially fluid tight seal about the wearer's eyes, the eyewear including at least one lens for positioning at least partially in front of a wearer's eyes, a frame adapted to mount the at least one lens for positioning the at least one lens in front of the eyes of the wearer; head mounting means adapted to attach the frame relative to a wearer's head, and at least one seal attached relative to said frame and located about a periphery of the wearer's eyes wherein the eyewear is wearable in a substantially fluid tight condition in which the at least one seal forms a substantially fluid tight seal about the wearer's eyes, and a free condition in which the eyewear is wearable with the seal spaced from the wearer's eyes.

The present invention relates to eyewear having multiple functions, including being usable as traditional eyeglasses, as air/water tight goggles and as glasses that enable airflow around the lenses, with the lenses thereof also being capable of providing vision correction and/or sun protection for the wearer.

The eyewear of the present invention includes at least one lens. Normally, a pair of lenses may be provided. Alternatively, a single unitary or monolithic lens may be provided which extends substantially across the wearer's face. The at least one lens will be appropriately mounted on or to the frame. This mounting may result in the at least one lens being mounted “to” the frame which normally occurs with the unitary lens or “in” the frame (within eyewires or rims) as normally occurs when a pair of lenses are provided.

The lenses can be any type of lens known in the field. In particular, the lenses may be polarised, tinted, photochromic, UV resistant and/or UV protective, prescription, or provide impact protection.

It is also particularly preferred that the at least one lens provided according to the invention will be hydrophobic. This may be a particularly important feature as the eyewear of the invention is adapted for use in water and other hostile environments and should be capable of shedding liquid quickly to leave vision unobscured.

The lens may be attached to the frame of the eyewear in any suitable manner. For example, an opening in the frame adapted to receive a lens may be provided with a circumferential groove or similar in order to receive an edge of the or each lens therein. In an alternative and preferred form, the lens may be attached to the frame with a sealing member located between the lens and the frame.

The frame of the eyewear of the present invention is typically at least partially rigid. Frames for glasses and the like normally include at least some of the following components:

Frame front: Front part of the eyeglass frame that holds the lenses in place and bridges the top of the nose.

Eye wires (rims): Part of the frame front into which the lenses are inserted.

Bridge: The area between the lenses that goes over the nose and supports the majority of the weight of the eyeglasses. Examples include:

A keyhole bridge is shaped like an old-fashioned keyhole and rests on the sides of the upper part of the nose. This style is for those with small or flat nose bridges.

A saddle bridge is shaped like a saddle and spreads the weight of the frame across the sides and the top of the nose. This style works well for heavy glasses or for those who are sensitive to pressure.

An adjustable bridge includes nose pads that can be adjusted for fit and comfort.

A double bridge has a reinforcing bar over the top of the bridge.

End pieces: Extensions of the frame front to which the temples are attached.

Hinges: Part of the frame that connects the frame front to the temples and allows the temples to swing.

Temples/earstems: Parts of the frame that extend over and/or behind the ears to help hold the frame in place.

Skull temples are the most popular for plastic frames. They are bent down slightly over the ear and follow the contour of the skull.

Comfort-cable temples hook behind the ear with a flexible metal cable and are good for children's glasses and for sport safety glasses.

Riding bow temples are similar to comfort-cables, except they are rigid and made of plastic.

Spring-hinged temples include hidden springs in the hinges that help keep the frame from slipping. They are sometimes more expensive, but usually more resistant to breakage.

Library (or paddle) temples are straight, so they can be slipped on and off easily. They are often used in reading glasses.

Nose pads: Plastic pieces that may be attached directly to the frame or to pad arms. They help keep the frame in its proper position.

Pad arms: Attachments that hold the nose pads in place and allow adjustments to help conform to the patient's bridge.

Top bar: A reinforcing bar that crosses the top of the glasses on some metal frames, popular in aviator glasses.

Temple tips: Plastic coatings that often cover the ends of the temples behind and/or over the ears.

Rimless frames (or mountings): The temples and bridge attach by mountings directly to the lenses without the use of eyewires or rims.

The frame of the present invention will typically be at least partially rigid. Normally, at least the frame front will be semi-rigid but flexible, but the bridge, end-pieces and/or earstems may also be semi-rigid but flexible. It is preferred that the frame portions including the frame front, including the bridge and end-pieces and typically the earstems as well, be sufficiently strong but deformable upon application of a sufficient force. The frame and lens(es) should be flexible enough to conform readily to the profile of a user's face.

The materials used in the production of modern eyeglass frames are normally plastic, metal, or a combination of the two (composites). Manufacturers select materials that are cost effective, adjust easily, offer safety and workability, hold the lenses properly, and resist breakage, corrosion, and heat. Popular frame materials include.

Plastics

Cellulose acetate (zylonite): The most commonly used plastic in eyeglass frames, cellulose acetate is relatively inexpensive, easy to work with, and comes in a wide variety of colors, textures, and patterns. The material is easily adjusted but tends to get brittle with age.

Cellulose proprionate: This is a lightweight material that can be injection molded making it ideal for intricate designs. Care must be taken when heating and adjusting frames made of this material because it will shrink and ruin with overheating.

Kevlar: Developed by DuPont for use in bulletproof vests, this plastic can withstand high impact such as that experienced in sporting events. The material is limited because it will not shrink or stretch, and it comes in few colors.

Nylon: Many sports and safety glasses are made of nylon because it is virtually unbreakable and relatively lightweight. The material is, however, difficult to adjust and can be manufactured only in darker colors. It can also become brittle over time.

Optyl: This material is somewhat lighter in weight than cellulose acetate and is hypoallergenic, an advantage to skin-sensitive patients. Frames made of optyl are more difficult to adjust because the material can return to its original molded shape, and the frames may break easily if not heated properly.

Polycarbonate: Polycarbonate is 10 times more impact-resistant than conventional plastic or glass and is the material of choice for children's, sports, and safety glasses. Polycarbonate lenses are thinner and lighter than conventional plastic or glass lenses, and the material comes with built-in ultraviolet protection.

Metals

Aluminum: Although very lightweight, aluminum is difficult to solder or weld, limiting its adaptability to different designs.

Cobalt: Usually used as part of a metal alloy, cobalt appears in high-quality frames that can be made lightweight, durable, flexible, and thin. It can also be successfully coated with a variety of colors, but is very expensive and consequently limited in use.

Monel: Monel is one of the most popular materials used in metal frames because it can be hammered into many shapes without losing its strength. It can also be made in various colors.

Nickel silver: This is a common material used in hinges, end pieces, and heavy bridges, and for the inner core of temples. It is more brittle than several other metals, making it less suited to the slender frames so popular today.

Phosphor bronze: This flexible alloy is about 95 percent copper, making it a good choice for temples.

Stainless steel: Stainless steel is one of the most corrosion-resistant metals, but is difficult to work with in the manufacturing process.

Trilam: This product is lightweight, however it has a shape memory, which can make frame adjustments difficult.

Composites

Carbon fiber graphite (CFG): CFG is a material made of nylon and carbon that provides the endurance of metal frames but is thin and lightweight. Although the material is black in its natural state, it is now available in a wide range of colors.

Copolyamide (MXP7): This material is a blend of nylon manufactured for frame-injection molding. The material is strong, lightweight, and durable, and it retains its shape unless heated.

Flexon7: Flexon7 is a proprietary material made from a titanium-based alloy with a high “memory” factor that enables a twisted frame to return to its original shape. In addition to making frames extremely durable, the Flexon material holds adjustments longer and is lighter in weight than traditional metal frames.

Titanium Ti-227: Titanium Ti-227 is nearly 50 percent lighter than most metal frame materials. It is hypoallergenic, non-corrosive, and one-third stronger than steel, making it an extremely desirable material for manufacturing frames. It's also difficult and expensive to extract and refine this abundant material.

Plastics or composite materials are particularly preferred given the use of the eyewear of the present invention in water and other hostile environments as well as the deformability required. However, a metal frame may find use if the seals are of sufficient quality.

The eyewear includes a head mounting means adapted to attach the frame relative to a wearer's head. The head mounting means of the eyewear of the present invention will typically include the earstems which are typically attached to the frame front. As stated previously, the earstems may be rigid or flexible.

Given that the eyewear of the present invention is intended to form a substantially air or fluid tight seal with a wearer's face, a more preferred means of mounting the eyewear relative to a wearer's head is to provide an adjustment strap attached to the eyewear and which extends substantially about the wearer's head. The adjustment strap may be associated with quick release mechanisms to enable multiple users of the eyewear and adjustment of the eyewear while in place on the head of the wearer.

In particular, the adjustment strap may be used with or without the earstems attached to the frame front.

In particular, a quick release clip or similar may be provided in order for a wearer to rapidly adjust the eyewear from the substantially fluid tight mode into the free mode and vice versa. One such example of a quick release clip or similar is known colloquially as a “cord lock”. Obviously, this type of clip would only be suitable for use with a flexible type head mounting means.

Various cord locks are known in the art, perhaps the most prevalent of which are the “barrel” or “plunger” locks shown in U.S. Pat. No. 4,288,891 to Boden; U.S. Pat. No. 5,197,166 to Meier et al.; U.S. Pat. No. 5,666,699 to Takahashi; U.S. Pat. No. 5,671,505 to Anscher; and U.S. Pat. No. 5,778,904 to Elsner.

One preferred cord lock has an aperture that allows a drawstring to be pulled through it when the lock is squeezed together. When not squeezed, a spring in the lock causes a movable portion within the barrel to press against the drawstring and prevent movement of the lock with respect to the drawstring.

Other means of mounting the eyewear relative to a wearer's head may be used, however it is important that the frame of the eyewear is retained relatively closely to the wearer's face at all times when the eyewear is being worn, and particularly when the eyewear is in the substantially air/fluid tight condition.

The eyewear includes at least one seal attached relative to said frame and located about a periphery of the wearer's eyes wherein the eyewear is wearable in a substantially fluid tight condition in which the at least one seal forms a substantially fluid tight seal about the wearer's eyes, and a free condition in which the eyewear is wearable with the seal spaced from the wearer's eyes.

The at least one seal therefore it is preferably provided as a peripheral seal around one or more the wearer's eyes. The at least one seal may be provided as a peripheral seal around the lens(es) of the eyewear.

The at least one seal of the present invention may be provided in either the free or the fluid tight conditions and once released, may be biased into the other of the conditions.

The at least one seal is movable between the free and sealed conditions. Preferably, this movement may be provided by moving either the seal relative to the frame, or, the seal may be provided in a fixed relation to the frame and the frame may be moved relative to the wearer's head, usually by moving the head mounting means. Preferably, the movement of the seal will be provided with a minimal adjustment in order to change from the free to the sealed condition.

The various types of seal may be used according to the present invention. For example, the seal may be any one of the following or a combination of the following types of seals, such list to be non-exhaustive:

a differential pressure seal, which maintains the seal with the wearer's face due to a pressure differential;

a silicon (or similar material) seal;

gel/latex/silicon seal; or

a deployable seal using deploying mechanisms to deploy or moved the seal between the free and sealed condition.

In embodiments where a silicon or a gel seal is used, the seal will preferably have a shape memory. Indeed, in preferred embodiments, the seal, regardless of type, will have a shape memory.

According to one particularly preferred embodiment, the seal may be mounted relative to the lens(es) with the lens(es) movably mounted to the frame. A mechanism is typically provided to move the lens(es) relative to the frame, towards and away from the wearer's face.

According to a further preferred embodiment, the frame of the eyewear of the present invention may have a seal overmoulded. In particular, the front of the frame which supports the lenses will typically have a pair of eye frame or rim portions which substantially surround a wearer's eye and are adapted to abut the user's face about their eye or eye socket. Preferably, the eye frame portions will be overmoulded with a resilient material in order to form a seal with the lens at the front. A rear portion of the seal may be provided in order to seal against the user's face when worn in the substantially fluid tight condition.

The preferred rear seal is a resilient extension which will preferably extend rearwardly from the frame seal and may have a depending portion extending either upwardly or downwardly in order to abut the user's face. Preferably, the rear seal will be highly compressible. One or more vent openings may be provided in the rear seal, these vent openings unobstructed when the eyewear is in the free condition but when the rear seal is preferable deformed during movement to the substantially fluid tight condition, the vent openings will typically be closed, normally due to the deformtion of the resilient material used to form the seal. The rear seal typically extends circumferentially about each eye frame or rim.

According to a most preferred embodiment, the eyewear will be provided with both an adjustment strap and a pair of earstems. Normally the earstems and the adjustment strap will engage with one another to allow the eyewear to assume the free and substantially fluid tight conditions.

The adjustment strap will normally be resilient and may be provided with a limited deformability. Stress inducing portions may be provided in the adjustment strap to allow the adjustment strap to flex and therefore be folded.

The adjustment strap will typically include a portion adapted to extend about the rear of the user's head and a pair of free end portions adapted to engage with each earstem in order to connect the adjustment strap to the earstems. Normally, the adjustment strap will be connected to the earstems in adjustable fashion. For example, each free end of the adjustment strap may be provided with one or more openings spaced over its length which may engage with an extension portion associated with each of the earstems. By moving the adjustment strap to an opening closer to the free end, the adjustment strap can be lengthened.

Preferably, each earstem may be provided with a locking means in order to releasably lock the free end of the adjustment strap to the earstem. In this configuration, the earstems will preferably be hollow, at least at the rear end. Preferably, the locking means will include a trigger which is accessible from the outside of the earstem located in opening in the earstem and which when depressed, can move within the hollow earstems to be drawn rearwardly to attach the adjustment strap. On a portion of the trigger but within the hollow earstems will typically be an extension portion to engage with the openings in the free end of the adjustment strap.

The trigger will typically be biased outwardly through provision of a spring-loaded portion adapted to force or bias the trigger outwardly unless sufficient force is provided to overcome the spring-loaded portion.

Guides may be provided in order to govern the movement of the trigger portion during actuation to release the adjustment strap. The trigger portion may be completely removable from the hollow earstems or may be extendable and retractable but not completely removable from the earstems. Typically, a locking trigger is provided on each earstem with the trigger actuable from the outside of the earstems.

A tension portion may be provided between the forward end of the rear trigger and extending forwardly to releasably engage with a tab member either attached to or integrally formed with the lens and which extends rearwardly through the eye rim and seal. The tension portion will preferably be fixed to the earstem along its length to define a forward tension strap portion and a rear tension strap portion. Alternatively, two separate tension portions may be provided. This allows the forward and rearward triggers to be operated independently of each other. The respective tension portions are biased toward the fixing or mid-point.

The tension portion will be the controlling member or portion for the actuation of the eyewear into the different conditions.

In use, the user will typically prime the rear trigger portion, by drawing the rear adjustment strap rearwardly. This will loosen the rear adjustment strap and engage the rear trigger in the rear or locking opening against the biasing force of the rear tension strap portion. The rear trigger portion is then locked to the earstem again, and the resilience of the rear tension strap portion will act to tighten the adjustment strap should the rear trigger portion be depressed, freeing the trigger portion. In this condition, the trigger portion may move such that the trigger portion is received within the earstem forwardly of the rear locking opening which tightens the adjustment strap.

Similarly, the forward trigger portion is also typically primed by drawing the eye rims and/or lens forwardly against the biasing force of the forward tension strap portion. The forward trigger portion is then locked to the earstems again, using the forward locking opening. The forward trigger may be depressed and it may be received within the earstem but more rearwardly of the forward earstem opening due to the biasing force of the forward tension strap portion. When released, through depression, the forward trigger moves rearwardly through the earstems, under the biasing force of the forward tension strap portion and moves the eyewear the substantially fluid tight condition.

According to a preferred embodiment, flexible attachment means are preferably attached to the lens(es) and pass through or over the frame, end pieces and earstems of the eyewear.

Alternative tightening/loosening means may be provided, typically on the end pieces or earstems. As the flexible attachment means tightened, the lens(es) with the seal is preferably moved into the sealed condition with the seal abutting the wearer's face and forming the seal therewith.

The tightening/loosening means will typically be independent of each other so that the lenses can be adjusted individually (if more than one lens is provided) or so that each side of a monolithic lens can be adjusted separately to take into account any non-symmetrical shape of the wearer's face. Alternatively, the flexibility of the frame itself may provide sufficient adjustment capability in order that individual lens adjustment means are not necessary.

A further alternative adjustment mechanism may be a tightening system whereby the adjustment strap can be tighten/loosened with a rotatable spool. The strap or a portion of the strap is threaded through a series of opposing guide members positioned on the frame or the earstems of the eyewear. The strap and guide members preferably have low friction surfaces to facilitate sliding of the strap along the guide members so that the strap evenly distributes tension across the eyewear. The tightening mechanism allows incremental adjustment of the tension of the strap. A release mechanism allows a user to quickly loosen the strap.

A rotatable spool for receiving a strap is provided, the spool rotatable in a first direction to take up strap and a second direction to release the strap. A knob is connected to the spool such that the spool can be rotated in the first direction in response to rotation of the knob. A releasable lock is provided for preventing rotation of the spool in the second direction. Releasing the lock permits the spool to rotate in the second direction in response to tension the strap, but the spool is not rotatable in the second direction in response to rotation of the knob. In one embodiment, the knob is only rotatable in the first direction.

According to an embodiment, the lens(es) will typically be more arcuate in order to space the lens(es) from the wearer's eye particularly in the sealed condition.

The frame of the eyewear of the present invention is typically held relative to a wearer's face by a head mounting means. Either the lens or the frame is mounted for movement relative to the wearer's head. The lens(es) may be mounted for movement relative to the frame such that as the frame is drawn rearwardly towards the wearer's face, the lens remains spaced from the wearer's eyes.

The above deploying mechanism is only one of such mechanisms that can be used. Other mechanisms for example include mounting the seal relative to the frame of the aisle where using one or more movable arms and with the wearer able to move the arms, whether directly or indirectly, and thereby the seal, between the sealed and free conditions.

Of course, the seal, or deployable mechanism may be biased into one or the other of the free or sealed conditions.

### BRIEF DESCRIPTION OF THE DRAWINGS

Various embodiments of the invention will be described with reference to the following drawings, in which:

FIG. 1 is a partially exploded, schematic view of eyewear according to one embodiment of the present invention.

FIG. 2 is a detailed view of the connection mechanism between the strap and the earstem according to a preferred embodiment.

FIG. 3 is a detailed view of the connection mechanism between the strap and the forward frame according to a preferred embodiment.

FIG. 4 is a detailed sectional view of the connection mechanism illustrated in FIG. 2.

FIG. 5 is a detailed sectional view of the lens with the seal according to a particularly preferred embodiment.

FIG. 6 is an isometric view of the forward frame showing the overmoulded seal used according to a preferred embodiment.

FIG. 7 is a view from above of the eyewear as worn by user in the glasses configuration.

FIG. 8 is a side view illustrating the eyewear has worn by user.

FIG. 9 is a view from above of the eyewear as worn by user in the goggles configuration.

FIG. 10 is a side view of the eyewear of a preferred embodiment in the locked condition.

FIG. 11 is a side view of the eyewear of a preferred embodiment in the open condition.

FIG. 12 is a sectional side view of the frame with a lens attached thereto according to a preferred embodiment.

FIG. 13 is an axonometric view of eyewear according to a further preferred embodiment of the present invention.

FIG. 14 is a view from below of eyewear according to the embodiment illustrated in FIG. 13.

FIG. 15 is a side elevation view of eyewear according to the embodiment illustrated in FIG. 13.

FIG. 16 is a sectional view of the embodiment illustrated in FIG. 15 along line A-A with the lens in the sealed condition.

FIG. 17 is a is a sectional view of the embodiment illustrated in FIG. 15 along line A-A with the lens in the unsealed or free condition.

FIG. 18 is a detailed view of an earstem of the embodiment illustrated in FIG. 13 with the cover removed and showing the trigger assembly in the primed condition which is also the free condition.

FIG. 19 is a detailed view of an earstem of the embodiment illustrated in FIG. 13 with the cover removed and showing the trigger assembly in the activated condition which is also the sealed condition.

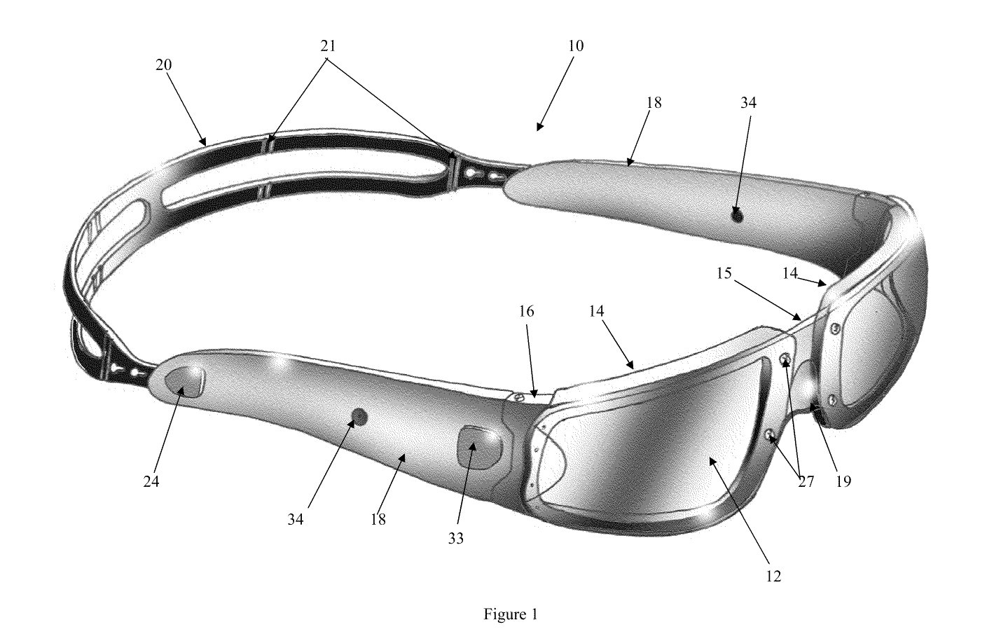

### DETAILED DESCRIPTION OF THE EMBODIMENTS

According to one embodiment of the present invention, eyewear in the form of sunglasses 10 is provided.

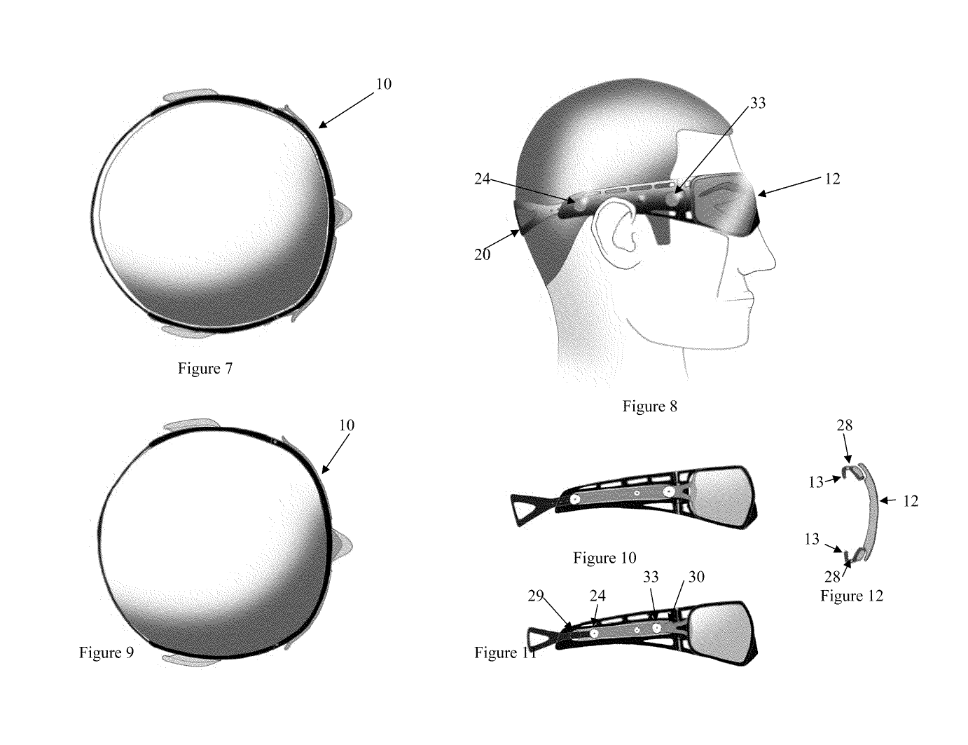

According to the illustrated embodiment, the sunglasses 10 are adapted to provide a substantially fluid tight seal about the wearer's eyes 11. The illustrated sunglasses 10 include a monolithic lens 12 for positioning in front of a wearer's eyes 11. The frame of the illustrated embodiment includes a pair of eye rims 14, each attached to an earstem 18 and the eye rims are connected to each other by the monolithic lens 12. The sunglasses 10 also include a head mounting strap to attach the frame relative to a wearer's head as illustrated in FIGS. 7 and 9 particularly.

Rear seals 13 are attached relative to each eye rim and located about a periphery of the wearer's eyes 11 so that the sunglasses 10 are wearable in a substantially fluid tight condition in which the rear seals 13 form a substantially fluid tight seal about the wearer's eyes 11, and a free condition in which the sunglasses 10 are wearable with the rear seal 13 spaced from the wearer's eyes 11.

The present invention relates to eyewear having multiple functions, including being usable as traditional sunglasses, as air/water tight goggles, with the lenses thereof also being capable of providing sun protection for the wearer.

The frame of the eyewear of the illustrated embodiment is at least partially rigid and includes the following components:

Eye wires (rims) 14: Part of the frame front into which the lenses are inserted.

Bridge 15: The area between the lenses that extends over the nose and supports the majority of the weight of the sunglasses. In the illustrated embodiment, the monolithc lens itself forms the bridge.

End pieces 16: Extensions of the frame front to which the temples are attached.

Hinges 17: Part of the frame that connects the frame front to the temples and allows the temples/earstems to swing.

Temples/earstems 18: Parts of the frame that extend over and/or behind the ears to help hold the frame in place.

Nose pads 19: Plastic pieces that may be attached directly to the frame or to pad arms. They help keep the frame in its proper position.

Plastics or composite materials are preferred materials of construction given the use of the eyewear of the present invention in water and other hostile environments.

The frame of the present invention is at least partially rigid. The frame portions including the frame front, including the end-pieces and the earstems as well is sufficiently strong but deformable upon application of a sufficient force. The frame and lens(es) should be flexible enough to conform readily to the profile of a user's face.

The frame of the eyewear of the illustrated embodiment has a seal 26 overmoulded over the eye rims. The eye rims 14 support the lens 12 and substantially surround a wearer's eye and are adapted to abut the user's face about their eye or eye socket. The eye rims 14 of the preferred embodiment are overmoulded with a resilient material in order to form a seal with the lens 12 at the front, each lens 12 being attached to the eye rims 14 using srews 27 in the illustrated embodiment. The lens 12 simply abuts the front of the eye rim 12 and is secured there with the overmoulded seal 26 between the eye rim 14 and the lens 12.

A rear seal 13 is provided on the in order to seal against the user's face when worn in the substantially fluid tight condition.

The rear seal 13 illustrated in FIG. 5 is integrally moulded with the overmoulded seal 26 and has a resilient extension which extends rearwardly from the overmoulded seal about the periphery of the eye rim 14 and has a depending portion extending downwardly in order to abut the user's face. The rear seal is highly compressible.

As illustrated in FIG. 12, a vent opening 28 is provided in the rear seal 13 on each eye rim 14, the vent openings 28 unobstructed when the eyewear is in the free condition but when the rear seal 13 is deformed during movement to the substantially fluid tight condition, the vent openings 28 are closed, normally due to the deformation of the resilient material used to form the seal.

According to a most preferred embodiment, the eyewear is provided with both an adjustment strap 20 and a pair of earstems 18. Normally the earstems 18 and the adjustment strap 20 engage one another to allow the eyewear to assume the free and substantially fluid tight conditions.

The illustrated adjustment strap 20 is resilient and is provided with a limited deformability. Stress inducing portions 21 may be provided in the adjustment strap 20 to allow the adjustment strap 20 to flex and therefore be folded.

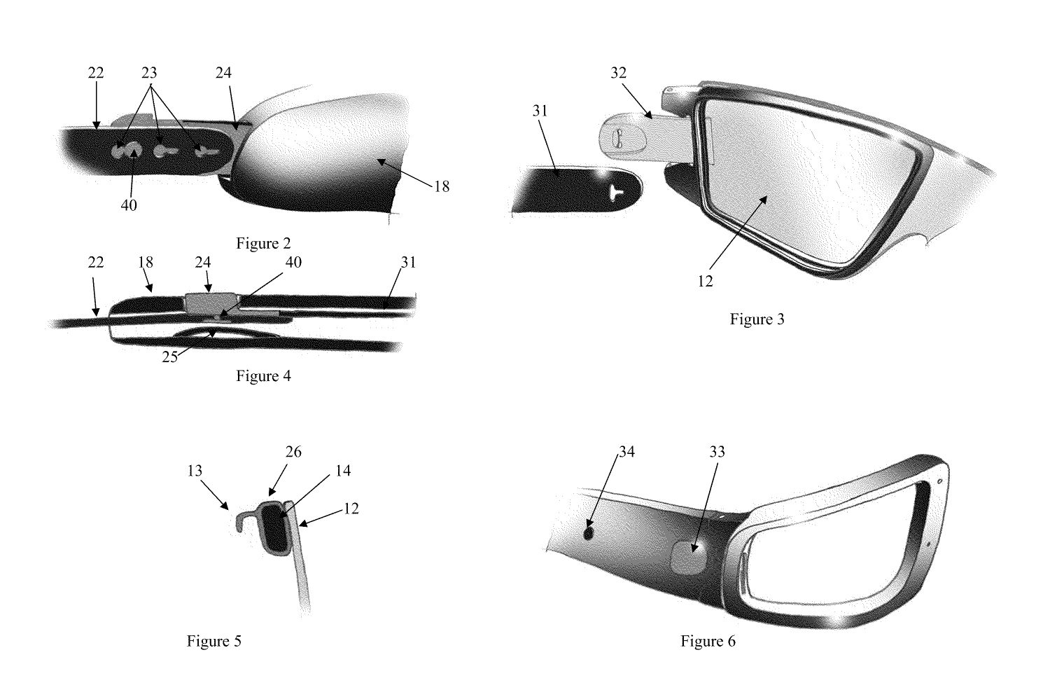

The illustrated adjustment strap 20 includes a portion adapted to extend about the rear of the user's head and a pair of free end portions 22 (best illustrated in FIGS. 2 and 4) adapted to engage with each earstem 18 in order to connect the adjustment strap t20 o the earstems 18. Normally, the adjustment strap 20 is connected to the earstems in an adjustable fashion. For example, each free end 22 of the adjustment strap 20 illustrated in FIGS. 2 and 4 is provided with multiple openings 23 spaced over its length adapted to engage with an extension portion associated with each of the earstems 18. By moving the adjustment strap 20 to an opening 23 closer to the free end, the adjustment strap 20 can be lengthened.

Each earstem of the illustrated embodiment is provided with a rear locking means in order to releasably lock the free end of the adjustment strap to the earstem. In this configuration, the earstems 18 are hollow at least at the rear end. Preferably, the locking means will include a rear trigger portion 24 which is accessible from the outside of the earstem 18 located in a rear locking opening 29 in the earstem 18 and which when depressed, can move within the hollow earstems 18 and can be drawn rearwardly, as illustrated in FIG. 2 to adjust the length of the rear adjustment strap. On a portion of the rear trigger 24 but within the hollow earstems 18 is an extension portion 40 to engage with one of the openings 23 in the free end of the adjustment strap 20 to adjust the length of the strap 20.

The rear trigger 24 is biased outwardly through provision of a spring-loaded portion 25 adapted to force the trigger 24 outwardly unless sufficient force is provided to overcome the spring-loaded portion 25.

Typically a rear locking trigger 24 and a forward locking trigger 33 is provided on each earstem 18 with each trigger actuable from the outside of the earstems 18. The forward trigger 33 is biased outwardly through provision of a spring-loaded portion 25 adapted to force the trigger 33 outwardly unless sufficient force is provided to overcome the spring-loaded portion 25. Further, the rear locking trigger is biased towards the front of the eyewear and the forward locking trigger is biased toward the rear of the headwear.

According to the illustrated embodiment, a tension strap 31 is provided between the forward end of the rear trigger 24 and extending forwardly to releasably engage with a tab member 32 either attached to or integrally formed with the lens 12 and which extends rearwardly through the eye rim 14. The tension strap 31 is fixed to the earstem along its length with a rivet 34 to define a forward tension strap portion and a rear tension strap portion. This allows the forward 33 and rearward 24 triggers to be operated independently of each other. The respective tension portions are biased toward the rivet 34.

The tension strap is the controlling member or portion for the actuation of the eyewear into the different conditions.

In use, the user will typically prime the rear trigger portion 24, by drawing the rear adjustment strap 20 rearwardly. This will loosen the rear adjustment strap 20 and engage the rear trigger 24 in the rear or locking opening 29 against the biasing force of the rear tension strap portion. The rear trigger portion 24 is then locked to the earstem 18 again, and the resilience of the rear tension strap portion acts to tighten the adjustment strap 20 should the rear trigger portion 24 be depressed. In this condition, the rear trigger portion 24 may be depressed again such that the trigger portion 24 clears the locking opening 29 and is received within the earstem 14 forwardly of the rear locking opening 29 which tightens the adjustment strap 20.

Similarly, the forward trigger portion 33 is also typically primed by drawing the eye rims 14 and/or lens 12 forwardly against the biasing force of the forward tension strap portion. The forward trigger portion 33 is then locked to the earstems 18 again, using the forward locking opening 30. The forward trigger 33 may be depressed and is then received within the earstem 18 but more rearwardly of the forward earstem opening 30 due to the biasing force of the forward tension strap portion. When released, through depression, the forward trigger 33 moved rearwardly through the earstems 18, under the biasing force of the forward tension strap portion and moves the eyewear the substantially fluid tight condition.

Therefore, the primed condition illustrated in FIGS. 7, 8 and 10 of each of the trigger portions is an extended position against the biasing force of the tension strap. Depression of the rear trigger releases the adjustment strap to achieve a tightened condition and depression of the forward trigger releases the eye rims to assume the substantially fluid tight condition. The free conditions (after depression) are illustrated in FIGS. 9 and 11.

The seals are movable between the free and sealed conditions. Preferably, this movement is provided by moving either the seal relative to the frame, or, the seal may be provided in a fixed relation to the frame and the frame may be moved relative to the wearer's head, usually by moving the head mounting means. Preferably, the movement of the seal will be provided with a minimal adjustment in order to change from the free to the sealed condition.

In the illustrated embodiment, the seal has a shape memory.

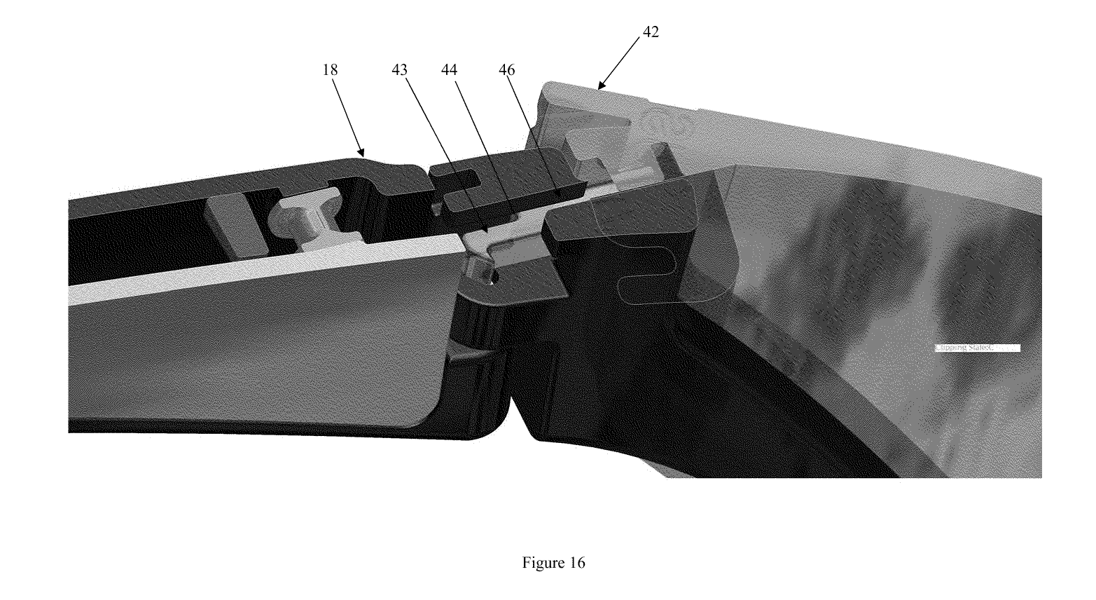

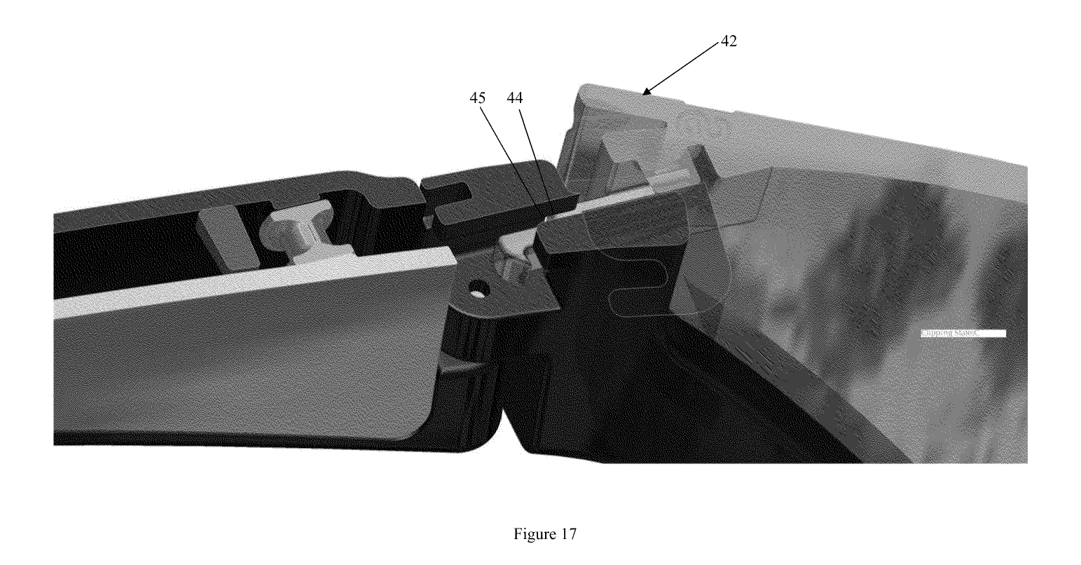

In an alternative embodiment illustrated in FIGS. 16 and 17, an optional feature of providing a releasable seal between the lenses 12 of the eyewear and the rims 14 of the frame of the eyewear is provided.

The lens 12 of this embodiment is typically hinged to the frame at hinge points 41, normally toward the nose bridge of the eyewear. The rear of the lens 12 is typically shaped to correspond to the frame and a peripheral portion of the lens overlies the frame. The lens 12 is moveable between a sealed condition in which the lens is sealed to the frame and a free condition in which the lens 12 is not sealed to the frame. A sealing member may be provided about the frame between the frame and the lens and/or between the frame and the user's face.

The lens 12 is preferably provided with a lateral extension 42 which acts as a gripping or depression portion. This portion (marked in the drawings with the word “push”) is associated with an extension 43 which is releasably engageable with a portion of the frame or earstem to move the lens 12 between the sealed and unsealed conditions. Typically the lens 12 is biased into the sealed condition.

The extension 43 preferably has a shoulder 44 and the frame or earstem is provided with an abutment shoulder 45 such that the lens 12 may be pulled forwardly (using the lateral extension 42) which moves the respective portions to allow the shoulder 44 of the extension 43 and the abutment shoulder 45 of the frame or earstem to engage one another, when released under the bias of the lens 12. This will typically hold the lens 12 in the unsealed condition. Depressing the lateral extension 42 rearwardly (and preferably inwardly) disengages the shoulder 44 from the abutment shoulder 45 returning the lens 12 to the sealed condition under the bias of the lens 12.

The extension 43 is preferably elongate and typically slides within a channel or opening 46 provided in the frame, which guides the movement. The extension 43 is preferably biased into the unsealed position which results in more or less automatic engagement with the abutment shoulder 45 when moved into the correct position. The bias of the extension 43 must therefore be overcome prior to movement of the lenses 12 into the sealed condition.

Typically, the abutment shoulder 45 is provided laterally outside the extension 43 and the extension 43 is biased outwardly. Movement of the extension 43 inwardly using the lateral extension 42 of the lens 12 is required to allow movement of the lens 12 to the sealed condition.

To create ventilation in and around the lens 12, the lateral extension 42 of the lens 12 (where it has the indentations behind the “push” label) is pulled forward and the shoulder or barb holds the lens away from the sealed frame. To seal the frames again the barb is overcome by pushing the lenses in again with a motion toward the centre of the wearer's head at the point marked “push”.

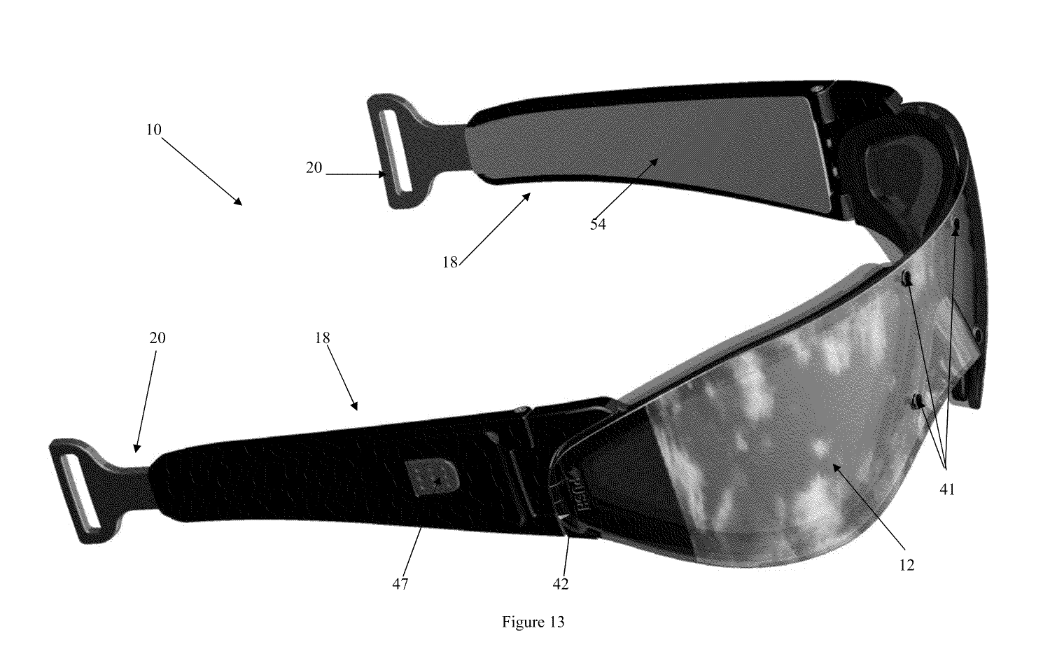

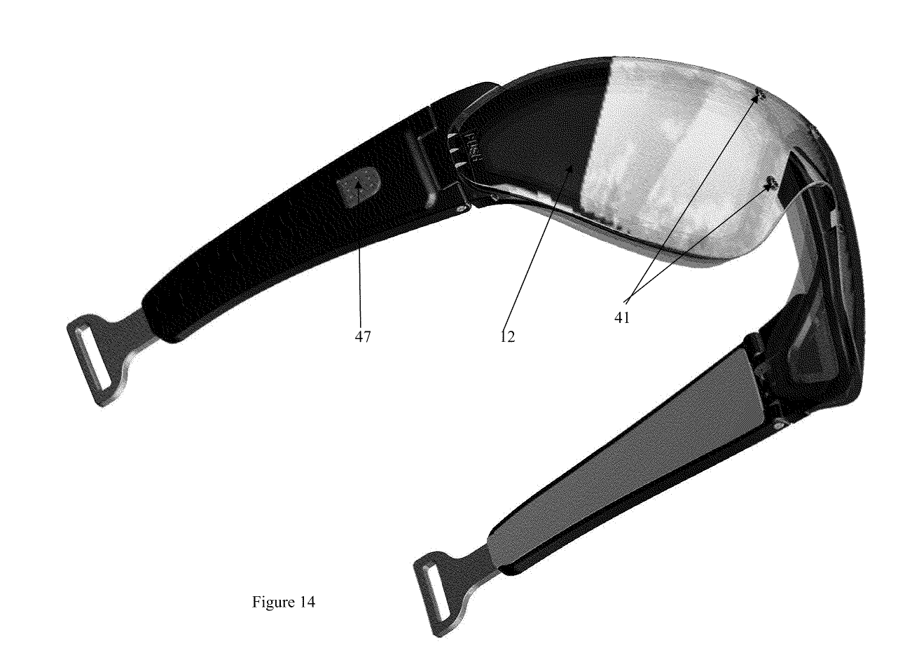

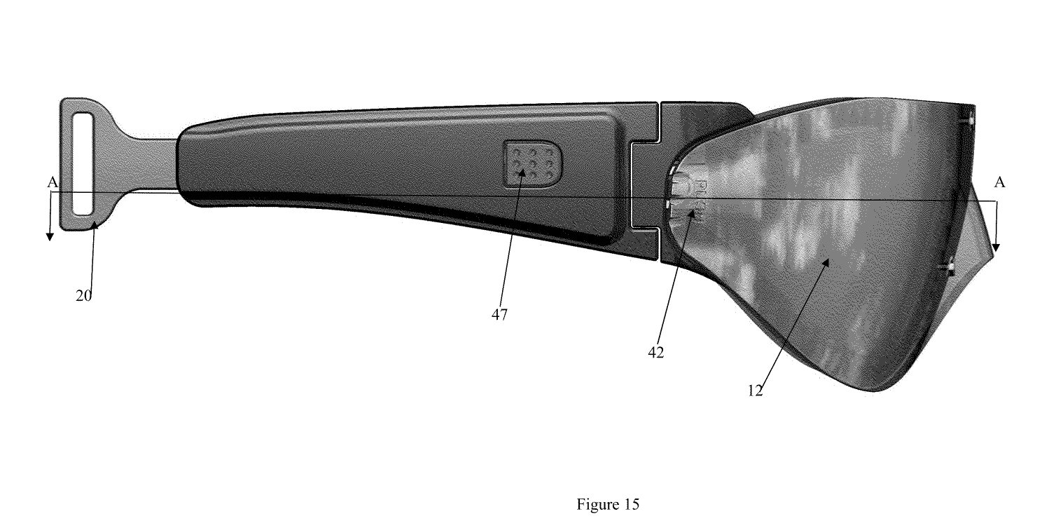

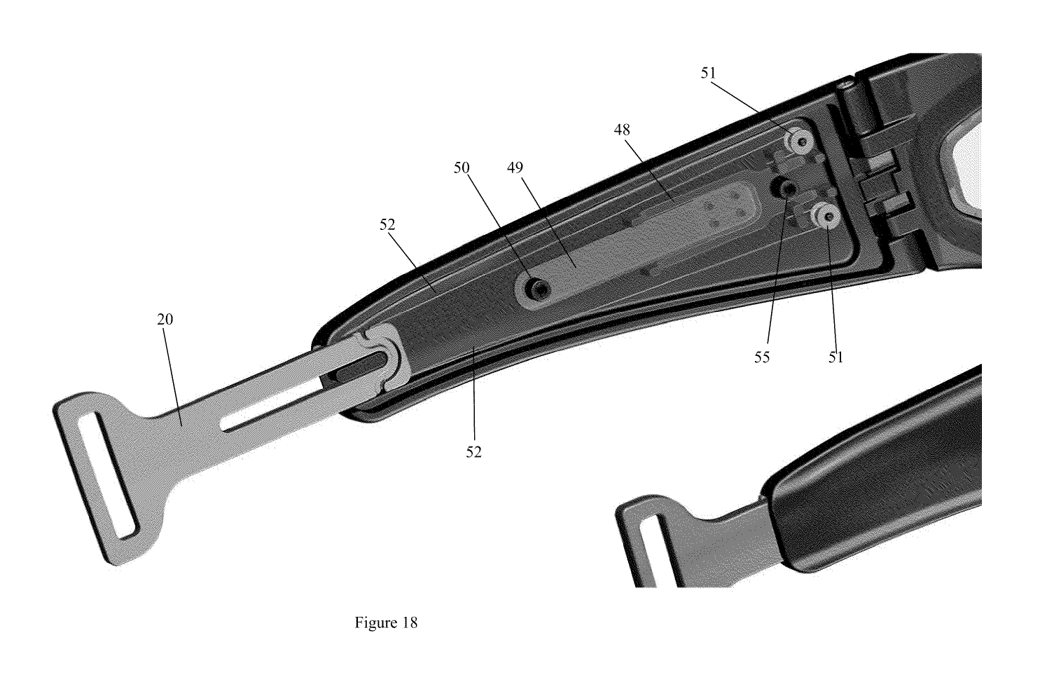

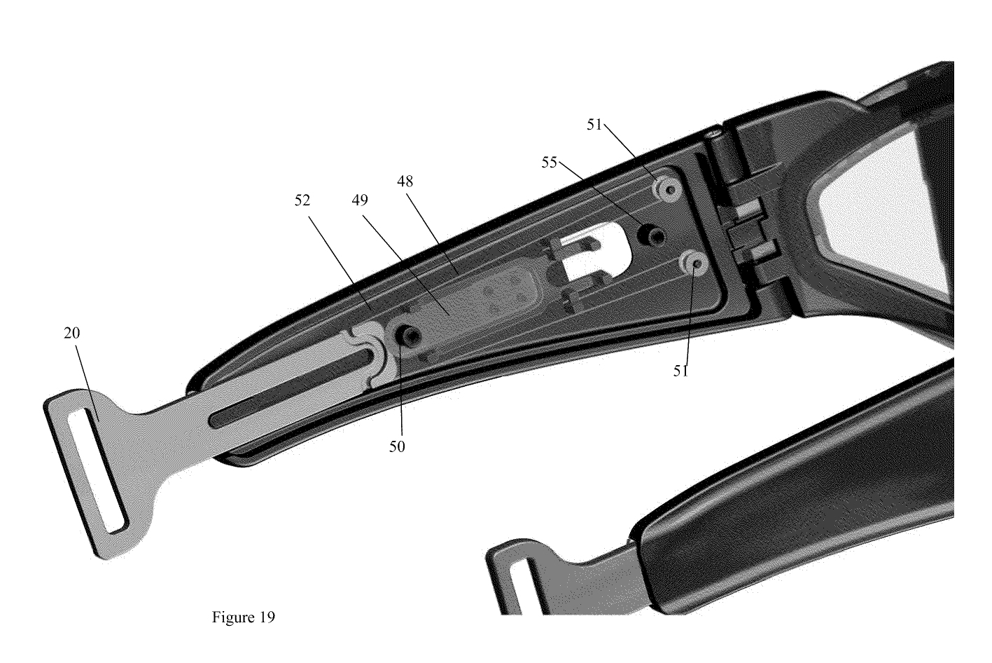

In an alternative embodiment illustrated in FIGS. 12 to 18 but particularly FIGS. 17 and 18, the strap 20 is provided in association with the frame to move the frame between a sealed condition against a wearer's face and a free condition in which the frame is not sealed against the wearer's face. A trigger mechanism is preferably mounted on each earstem 18 and a tension mechanism is provided in association with the trigger mechanism.

The trigger mechanism will preferably include a release button 47 or similar accessible from outside the earstem to trigger actuation of the tension mechanism to move the frame into the sealed condition against a wearer's face. The earstem 18 is preferably hollow and contains other components actuable by the release button.

The trigger mechanism is associated with a locking assembly for temporarily locking the strap into the free condition.

The locking assembly typically includes a locking body 48 associated with the head strap 20, normally through a resilient portion 49 which undergoes forced temporary deformation (lengthening) during the priming step. Triggering release of the locking assembly allows the natural bias of the resilient portion 49 to assert itself and moves the strap 20 into the sealed condition.

The locking body 48 will typically be robustly attached or formed with the resilient portion 49. The resilient portion 49 will preferably be mounted relative to the earstem and normally to a fixed point 50 along the earstem in order to be forcibly deformed against that fixed point 50.

The locking body 48 is preferably attached to the strap 20 via one or more pulley components 51 which allow extension of the strap 20 when the locking body 48 is in the primed condition. The pulley components 51 are preferably provided towards a forward end of the earstem. Normally there will be two pulley components 51 to better balance the mechanism.

The strap 20 is attached to one or more elongate, and substantially inextensible fibre members 52 which extend from the strap 20 forwardly about the pulley components 51 and then rearwardly again to the lock body 48.

Due to this configuration, drawing the strap 20 rearwardly during priming will force the lock body 48 forwardly against the biasing force of the resilient portion 49.

One or more catch elements are provided in the earstem and mounted to the earstem to engage the lock body 48 when moved to the primed condition. It is preferred that the catch elements include a ramp portion with a catch edge and the lock body 48 includes a corresponding shoulder such that the lock body 48 can slide relative to the catch elements until the shoulder engages with the catch edge. Normally the ramp portion will extend toward an inner side of the earstem (closer to the head of the user) and the catch edge will be provided at a forward portion (towards the front of the earstem). Again, normally a pair of opposed catches and at least one shoulder will be provided to provide balance to the mechanism.

The trigger button 47 of the trigger mechanism will preferably be associated with a portion of the lock body 48 adjacent the shoulder, and is normally biased outwardly. Depression of the trigger button 47 will normally displace the shoulder of the lock body, disengaging the shoulder from the catch element and allowing the natural bias of the resilient portion 49 to assert itself and moving the strap 20 into the sealed condition.

Alternatively, the lock body 48 may be provided with a shoulder defining the button 47. The shoulder of the button 47 may engage with a rear periphery of an opening in the earstem when the mechanism is primed. Depression of the button will disengage the shoulder from the periphery and allow movement of the strap relative to the earstem.

In an alternative embodiment, the fibre elements may be resilient and the resilience of the fibre components can be used as the resilient portion which undergoes forced temporary deformation (lengthening) during the priming step.

The tension mechanism is preferably biased into a tightened condition and is primed when the trigger mechanism is engaged and adapted to tighten the rear adjustment strap 20 when the rear trigger mechanism is actuated.

It is preferred that the earstem will be provided with a cover 54 to seal the mechanism within the hollow earstem. Further, one or more guides 55 will preferably be provided to guide the movement of components, particularly the lock body 48.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

What is claimed is:

1. Eyewear for use by a wearer, said eyewear providing a substantially fluid tight seal about the wearer's eyes, the eyewear including at least one lens for positioning at least partially in front of a wearer's eyes; a frame adapted to mount the at least one lens for positioning the at least one lens in front of the eyes of the wearer; head mounting means adapted to attach the frame relative to a wearer's head; and at least one seal attached relative to said frame and located about a periphery of the wearer's eyes wherein the eyewear is wearable in a substantially fluid tight condition in which the at least one seal forms a substantially fluid tight seal about the wearer's eyes, and a free condition in which the eyewear is wearable with the seal spaced from the wearer's eyes.

2. Eyewear as claimed in claim 1 wherein a single unitary or monolithic lens is provided extending substantially across the wearer's face.

3. Eyewear as claimed in claim 1 wherein the frame which supports the lenses has a pair of eye rim portions which substantially surround a wearer's eye and are adapted to abut the wearer's face about the eye or eye socket.

4. Eyewear as claimed in claim 3 wherein the at least one seal is a peripheral seal around each of the eye rim portions.

5. Eyewear as claimed in claim 3 wherein the eye rim portions each have an overmoulded seal.

6. Eyewear as claimed in claim 5 wherein the eye rim portions are overmoulded with a resilient material in order to form a seal with the lens at the front of the eyewear.

7. Eyewear as claimed in claim 5 wherein a rear seal is provided peripherally around each of the eye rim portions in order to seal against the user's face when worn in the substantially fluid tight condition.

8. Eyewear as claimed in claim 7 wherein the rear seal has a resilient extension extending rearwardly from the overmoulded seal including a depending portion in order to abut the user's face.

9. Eyewear as claimed in claim 8 wherein one or more vent openings are provided in the rear seal, these vent openings unobstructed when the eyewear is in the free condition but when the rear seal is deformed during movement to the substantially fluid tight condition, the vent openings are closed.

10. Eyewear as claimed in claim 1 wherein the eyewear has both a rear adjustment strap and a pair of earstems.

11. Eyewear as claimed in claim 10 wherein the adjustment strap is resilient having a limited deformability and one or more stress inducing portions to allow the adjustment strap to flex and be folded.

12. Eyewear as claimed in claim 10 wherein the adjustment strap includes a portion adapted to extend about the rear of the user's head and a pair of free end portions adapted to engage with each earstem in order to connect the adjustment strap to the earstems.

13. Eyewear as claimed in claim 10 further including a rear trigger mechanism mounted on each earstem and a tension mechanism provided between the rear trigger mechanism and the earstem biased into a tightened condition and primed when the rear trigger mechanism is engaged and adapted to tighten the rear adjustment strap when the rear trigger mechanism is actuated.

14. Eyewear as claimed in claim 10 further including a forward trigger mechanism mounted on each earstem mounted on each earstem and a tension mechanism provided between the forward trigger mechanism and the earstem biased into the substantially fluid tight condition, primed when the forward trigger mechanism is engaged and adapted to force the frame into the substantially fluid tight condition when the forward trigger mechanism is actuated.

15. Eyewear as claimed in claim 13 wherein the tension mechanism is a single resilient strap fixed to the earstem at a point along its length to define a forward tension strap portion and a rear tension strap portion, the forward tension strap portion biased towards the fixing point and the rear tension strap portion biased towards the fixing point.

16. Eyewear as claimed in claim 13 wherein the trigger mechanism has a trigger and are primed by drawing the trigger against the biasing force of the tension mechanism until the trigger mechanism is engaged until actuation releases the trigger mechanism.

17. Eyewear as claimed in claim 16 wherein the respective triggers are located within a hollow earstem and extend through an opening in the earstem.

18. Eyewear as claimed in claim 17 wherein the respective triggers are biased outwardly through provision of a spring-loaded portion adapted to force the respective trigger outwardly unless sufficient force is provided to overcome the spring-loaded portion.

19. Eyewear as claimed in claim 18 wherein when depressed, the respective trigger portions are received and move inside the respective hollow earstem.

20. Eyewear as claimed in claim 1 wherein the frame of the eyewear is flexible to conform to a wearer's face.
